(19) United States
(12) Patent Application Publication
(10) Pub. No.: US 2003/0050866 A1
(43) Pub. Date: Mar. 13, 2003

(54) Product selling system and method

(75) Inventor: Koichi Fujioka, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/235,560

(22) Filed: Sep. 6, 2002

(30) Foreign Application Priority Data
Sep. 10, 2001 (JP) 2001-273927

(51) Int. Cl. G06F 17/60

(52) U.S. Cl. 705/27

(57) ABSTRACT

A product selling system is provided that can be precisely grasp a feeling of fitting with a body on the screen even when apparel product has extensibility and workability. The product selling system comprises a body image creator for creating, based on information on a body type of purchaser, a three-dimensional image of the body of said purchaser; a product information provider for providing information on a product supplied by a seller; and an image synthesizer for creating a three-dimensional image based on the product information and then synthesizing the created three-dimensional image with the three-dimensional image of the purchaser. The product information supplied by the product information provider includes at least information on design of the product, measurements of respective portions of the product, a degree of extension (if a product has extensibility), and adjustability and an allowable work range (if a size of a product is workable). The image synthesizer corrects a three-dimensional image of the product within the extension range or allowable work range thereof and then re-synthesizes and displays the corrected image with the three-dimensional image of the purchaser.

### BACKGROUND OF THE INVENTION

The present invention relates to a product selling system and method. More particularly, the present invention relates to a product selling system and method that, when a purchaser wears an article such as clothing or shoes on trial, can determine whether or not the size thereof fits the purchaser.

Conventionally, to manufacture and sell ready-made clothes or shoes, the maker generally supplies the similar products of a variety of sizes. Each size is indicated on a tag attached to a product. Consumers refer to tags at a retail shop to choose and buy products of suitable sizes. However, although there are an enormous number of manufacturers, products each labeled as the same size are often different delicately in size every manufacture or every product. For that reason, it may be understood that the size indicated on a tag is referred to provisionally. Consumers actually try products at detail shops and finally determine whether or not the products fit their body sizes.

Moreover, on current product sales, pairs of slacks, for example, are generally distributed on the market without adjusting the hems. A consumer tries a pair of slacks at a retail shop. Extra lengths of a pair of slacks are checked and the hems thereof are adjusted. Thus, the finished pair of slacks is handed over to the purchaser. In addition of the hem adjustment, in the case of a pair of ready-made slacks, the girth of a waist or thigh is cut shorter or is widened as large as possible, if the purchaser desires, after trial. This procedure requires a certain period of time between a request and an end of working. Consequently, the purchaser cannot make sure a product silhouette after working until the working finishes.

In the e-mail-order selling business of clothes, utilizing the Internet, methods of performing virtually fitting at a virtual shop on a network have been proposed. According to, for example, JP-P1994-41805A and JP-P1999-265243A, information on the figure (or body type) of a purchaser, such as height and chest size, is compared with information on sizes of various portions of a product. When the waist size of a product is smaller than that of the purchaser, it is informed that the product does not fit the purchaser. Alternatively, an image of a purchaser body is previously created based on personal information on the height or chest size. The created image and an image of a product desired by the purchaser are displayed in a superimposing mode. Thus, an external appearance of the purchaser wearing the product as well as a feeling of fitting can be ascertained.

However, in actual, some products may not allow to be worn on trial at a retail shop. In such a case, a purchaser has to recognize a fitting feeling by merely putting a product on his/her body. When wearing the product after the purchase, the purchaser may notice the inconvenience in size.

Moreover, a fitting room in crowded state at a retail shop prolongs the waiting time for fitting. This causes poor turnover of goods and low buying power at the retail shop. Moreover, when a purchaser does not know its own body sizes, the purchaser has to ask a clerk to measure the sizes every time or to determine a suitable size. This requires to hold clerks that can respond requests from purchasers and to train them, thus deteriorating the efficiency of clerks.

In order to avoid such problems, it is convenient that a purchaser can superimpose a body image with a product image at a real retail shop, thus ascertaining the resultant image on the purchaser.

Recently, many clothes made of synthetic fibers with extensibility are on the market. The extensibility of a synthetic fiber depends on the substance or on the spinning method and it is difficult to grasp the extensibility from its external appearance. In the case of products that cannot be worn on trial, it is fairly difficult to imagine the fitting feeling, with the extensibility considered.

In the above-mentioned conventional technique, the seller's server merely performs the steps of providing information on the shape, size, and color pattern of texture of a product and then superimposing images on a purchaser terminal. Consequently, this technique cannot deal with the extensibility of a product.

### SUMMARY OF THE INVENTION

The present invention is made to solve the above-mentioned problems. An object of the present invention is to provide a system capable of ascertaining a correlation between a purchaser's body size and a product chosen at a real retail shop, using an image displayed on a terminal, without actually fitting. This system can suitably evaluate, as determination factors for purchase, the extensibility of a product and a workable size range.

In order to achieve the above-mentioned object, the present invention is characterized by a product selling system, wherein whether or not the size of a product fits the body of a purchaser is determined, comprises a purchaser's terminal operated by a purchaser of a product; a terminal belonging to a seller of an apparel product, communicable to the purchaser's terminal; a body image creator for creating, based on information on the body type of the purchaser, a three-dimensional image of the body type; a product information provider for providing information on a product supplied by the seller; and an image synthesizer for creating a three-dimensional image based on the product information and then synthesizing the created three-dimensional image with the three-dimensional image of the purchaser. The product information supplied by the product information provider includes at least information on design of the product, measurements of respective portions of the product, and a degree of extension if the product has extensibility. The image synthesizer corrects a three-dimensional image of the product within the extension range thereof and resynthesizes and displays the corrected information with a three-dimensional image of the purchaser.

In the system configuration, when entering a desired product to a purchaser's terminal at a retail shop, a purchaser can ascertain a three-dimensional image of the purchaser wearing the product. The purchaser can grasp the fitting feeling without fitting the product at a retail shop so that uncertainty about a product being difficult to try can be eliminated. Moreover, the image synthesizer re-synthesizes an image, with the extensibility of a product considered, a suitable image after fitting can be ascertained even in a product made of an extensible substance.

In the product selling system, when the outline of the purchaser and the outline of the product interfere with each other in a composite image of the body of the purchaser and the product, the image synthesizer corrects and re-synthesizes a three-dimensional image of the product. When a purchaser's body is superimposed with a three-dimensional image of a product, the portion where an image contour interferes, or only the portion where the product size is small is widened and re-synthesized within an allowable extension range. Thus, when extensible clothes fitting a body are used, an accurate fitting image can be obtained.

In the product selling system, the product information provided by the product information provider further includes measurements of the product, if workable, and an allowable work range thereof.

The image synthesizer corrects a three-dimensional image of the product within the allowable work range thereof, re-synthesizes the corrected three-dimensional image with a three-dimensional image of the purchaser, and then displays a composite image.

In this system configuration, the correlation between a product design and a purchaser's body after working can be ascertained with images even before a product is actually worked. Hence, it can be avoided that a previously imagined image is different from an image after changing.

Moreover, the product selling system according to the present invention may further comprise a working section for working the product at a request from the purchaser. In this case, the image synthesizer transmits, when an image of the product is corrected, the corrected information to the working section. The working section creates work information on portions and measurements to be worked based on the corrected information, whereby the product is worked. As described above, when a product image is corrected to ascertain an image after working, work information on sizes to be worked is automatically created and processed based on the corrected information. For example, when the hems of slacks are worked, it is not needed to determine the measurements by pinning after trial. This can eliminate the time and labor wasted by a purchaser and at a retail shop.

Moreover, according to the present invention, the seller's terminal comprises a retail shop's terminal installed at each retail shop and a maker's terminal linked to the retail shop via a network and installed at a production/distribution source of the product. The retail shop's terminal has means that requires, when not having information on a product required by the purchaser, information on the product from the maker's terminal.

It may be assumed that the maker's terminal at a product production/distribution source has information on all products provided by the maker but a terminal installed at a retail shop does not have information on new products. In this case, when a retail shop's terminal requires product information from a maker's terminal via a network, it can be avoided that a purchaser cannot create an image of a desired product.

### BRIEF DESCRIPTION OF THE DRAWINGS

This and other objects, features and advantages of the present invention will become more apparent from the following detailed description taken in conjunction with the attached drawings, in which;

FIG. 1 is a block diagram illustrating the configuration of a product selling system according to the present invention;

FIG. 2 is a flowchart explaining a body image creating process for the system shown in FIG. 1;

FIG. 3 is a flowchart explaining an example of a basic operation of the system shown in FIG. 1;

FIG. 4 is a flowchart explaining of one embodiment of an image inspection/correction step shown in FIG. 3; and

FIG. 5 is diagram illustrating an image displayed on the purchaser's terminal shown in FIG. 1.

### DESCRIPTION OF THE EMBODIMENTS

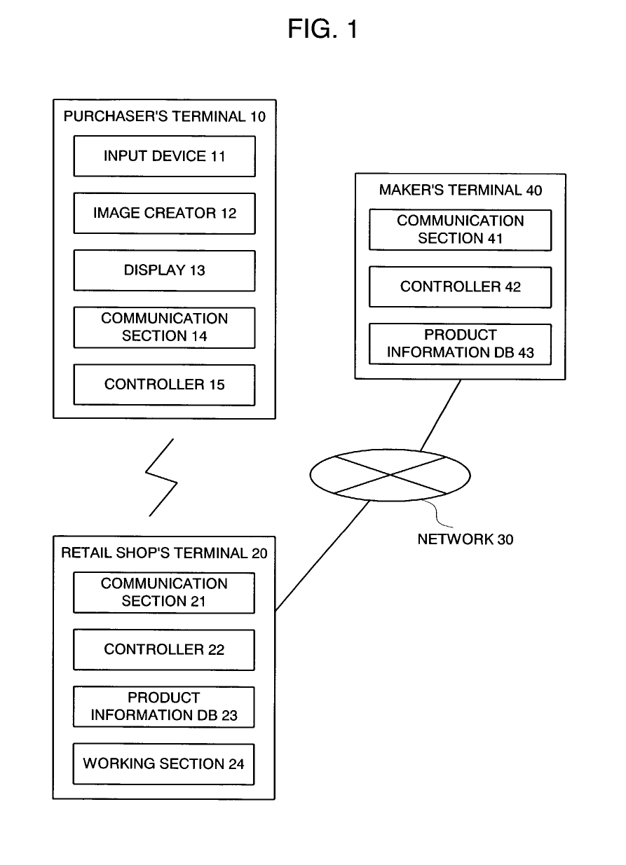

An embodiment according to the present invention will be explained in detail below by referring to the attached drawings. FIG. 1 is a block diagram illustrating the whole of a product selling system according to the present invention. As shown in FIG. 1, the product selling system consists of a purchaser's terminal 10 being a mobile communications terminal held by a purchaser, a retail shop's terminal 20 communicable to the purchaser's terminal 10 and installed at a retail shop that sells products, and a maker's terminal 40 communicable to the retail shop's terminal 20 via the network 30 and installed at a product maker.

The purchaser's terminal 10 is a device with an information processing function, for example, a mobile telephone or PDA. The purchaser's terminal 10 includes an input device 11 that inputs at least information on a body type (figure) of a purchaser or a model number of a product, an image creator 12 for creating various three-dimensional images based on the body type information or the product information entered, a display 13 for displaying three-dimensional images of a purchaser or product, a communication section 14 for communicating with the retail shop's terminal 20, and a controller 15 for controlling various operations of the purchaser's terminal 10. The input device 11 has at least a numeric-key pad with which a purchaser enters body type information or product model numbers. The input device 11 may be a scanner that reads bar codes on tags attached to products.

The retail shop's terminal 20 is installed at each retail shop where purchasers actually buy products. The retail shop's terminal 20 includes a communication section 21 for communicating with the purchaser's terminal 10 or the maker's terminal 40, a controller 22 for controlling various operations of the retail shop's terminal 20, a product information database 23 for holding product information and product model numbers, which are registered correspondingly, and a working section 24 conceptually including a staff that shortens the hems at a purchaser's request.

Tags, each on which information about a product model number (including the type and size of a product), a maker's name, a maker's access destination, and so on, is indicated, are attached to products displayed at a retail shop.

The network 30 is, for example, a broadband network such as the Internet.

The maker's terminal 40 is a terminal installed in each maker providing various products. The maker's terminal 40 includes a communication section 41 for communicating with the retail shop 20, a controller 42 for controlling various operations of the maker's terminal 40, and a product information database 43 for holding product information and product model numbers of all products supplied by a maker, which are registered correspondingly.

In the retail shop 20, the product information database 23 registers product information by product, including design, size of each portion, material and color, degree of extension (if a product has an extensibility), and an allowable working range (if the size of a product is workable). In the maker terminal 40, the product information database 43 registers product information by product, including design, size of each portion, material and color, degree of extension (if a product has an extensibility), and an allowable working range (if the size of a product is workable). In specific explanation, the product information on, for example, slacks includes information on basic design, sizes (of waist, hip, and girth of thigh), and length from above crotch and length from under crotch, and material and color. The product information also includes information (extensibility) on how long a portion of an extensible material further extends and information (processing allowable working range) on that the girth of a waist can be further shortened 4 cm and that the girth of a thigh can be further widened 2 cm.

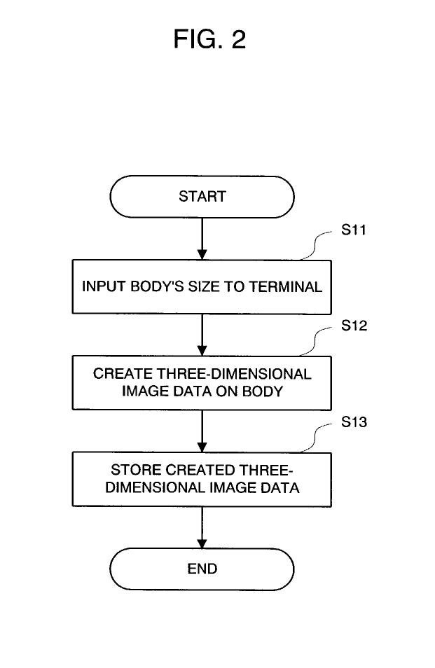

Each of FIGS. 2 to 4 is a flowchart explaining the operation of the product selling system. FIG. 2 shows the step of creating a three-dimensional image of a purchaser's body image at the purchaser's terminal 10.

As shown in FIG. 2, a purchaser enters sizes of necessary portions of a body using the input device 11 of the purchaser's terminal 10 (step S11). This step may be performed by inputting information on a body previously measured at a different place into the purchaser's terminal 10. The image creator 12 creates a three-dimensional image of the purchaser's body based on the input information (step S12). The created three-dimensional image is saved into the purchaser's terminal 10 (step S13) and then is read out every time a product is bought.

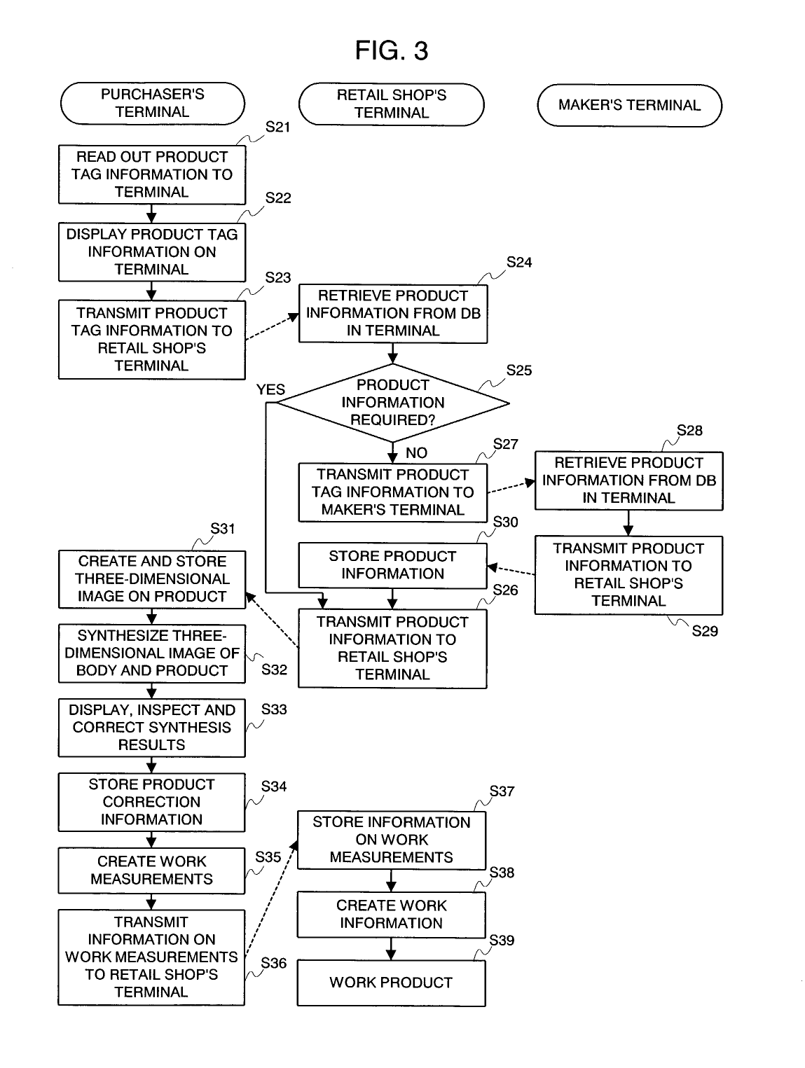

FIG. 3 is a flowchart explaining the operation when a purchaser buys products at a retail shop. When finding a favorite product at a retail shop, the purchaser enters the tag information including a model number indicated on a tag thereof into the purchaser's terminal 10 (step S21). This step may be performed through reading the bar code indicated on the product tag with a scanner.

The input tag information is displayed on the display 13 (step S22). After confirmation by the purchaser, the tag information is sent to the retail shop's terminal 20 (step S23).

In response to the tag information, the retail shop's terminal 20 retrieves whether or not information on the product corresponding to the model number is within the product information database 23 (step S24).

As a result, when the product information exists (YES in step S25), the retail shop's terminal 20 reads it and transmits to the purchaser's terminal 10 (step S26). When the product information database 23 in the retail shop's terminal 20 has no product information of the product (NO in step S25), the tag information is transmitted to the maker's terminal 40 via the network 30 (step S27).

In response to the tag information, the maker's terminal 40 retrieves the product information corresponding to the model number of the tag information from the product information database 43 (step S28) and then transmits it to the retail shop's terminal 20 (step S29).

In response to the product information, the retail shop's terminal 20 newly saves it in the product information database 23 to accept subsequent requests (step S30) and transmits it to the purchaser's terminal 10 (step S26).

The purchaser's terminal 10 extracts information on basic design and on measurement of each portion from the received product information and creates and saves a three-dimensional image of a product based on them (step S31).

Next, the purchaser's terminal 10 performs a synthesis process by superimposing a three-dimensional image of a purchaser's body, saved in the terminal 10, with the three-dimensional image of the product (step S32). As a result, the display 13 manifests a three-dimensional image where the purchaser is in the product.

Thereafter, the purchaser's terminal 10 inspects the synthesis result (step S33), corrects, if necessary, the product image and stores the corrected information on the product (step S34).

Here, the image inspection/correction process shown in the steps S33 and S34 will be described in detail.

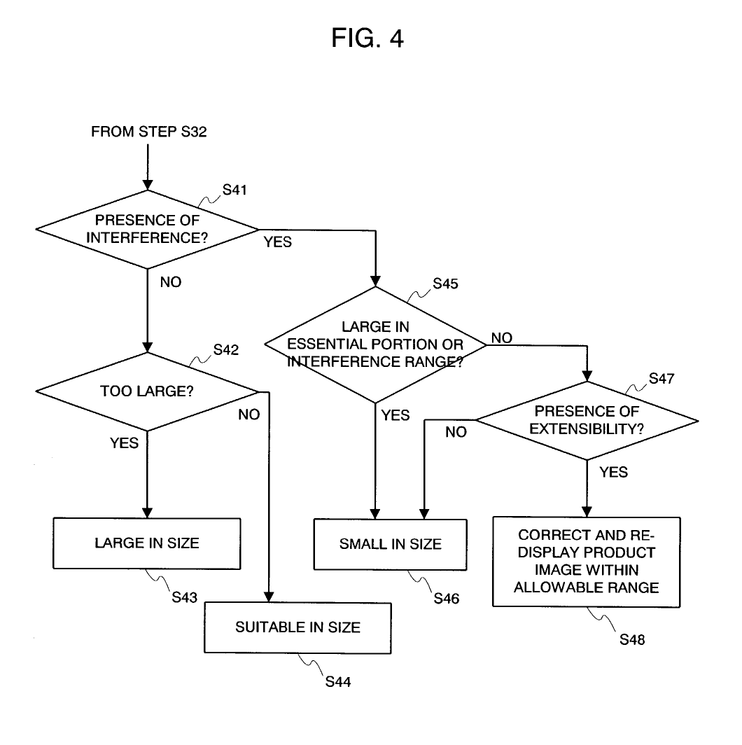

FIG. 4 shows an example of an image inspection/correction process in the steps S33 and S34.

During this process, the controller 15 in the purchaser's terminal 10 scans whether or not the image obtained in the step S32 contains a portion where a product image interferes with a body image (step S41). This process is carried out through detecting whether or not a superimposed three-dimensional image contains a portion where the contour forming a purchaser's body image and the contour forming a product image cross. When the size of each portion obtained from information about a purchaser's body is larger than the size of the corresponding portion of the product, the controller 15 determines that the corresponding portion is in interference. The interference portion and the range thereof are inspected.

When the synthesis image has no interference portion (NO in step S41), the controller 15 determines whether or not the product size is too large (step S42). In this determination, the numerical value of each portion of the product is compared with that of the corresponding portion of the body. When the comparison value at each portion exceeds a predetermined value, the controller 15 determines that the sized of the product is too large. Thus, the controller 15 shows that the purchaser should choose a product smaller one level, on the display 13 (step S43). When the determination is NO in the step S42, display 13 manifests that the size of this product is suitable for the purchaser (step S44).

In the step S41, when a synthesis image of a product and a body includes an interference portion (YES in step S41), it is determined whether or not the interference portion is a predetermined essential portion or the interference range is larger than a predetermined range (step S45). When the interference portion is a predetermined essential portion or the interference range is larger than a predetermined range (YES in step S45), the display 13 manifests that size is small (step S46).

When an interference portion exists but is not an essential portion or when an interference range is small (NO in step S45), the controller 15 inspects material information and extensibility of each portion, based on product information (step S47). Then when the product has extensibility, the controller 15 corrects the product image within the extension range and re-synthesizes the corrected data with information on the body (step S48). In this procedure, provided that the product has a slightly smaller portion to a purchaser's body, the smaller portion is widened within an allowable range if the product has the extensibility, so that the three-dimensional image of the product image is corrected. The corrected three-dimensional image is visually re-superimposed with the purchaser's body image. In this case, the extended portions may be color displayed and captioned on the display 13 for easy understanding by the purchaser.

With the product having no extensibility (NO in step S47), the display 13 manifests that the size is small (YES in step S47).

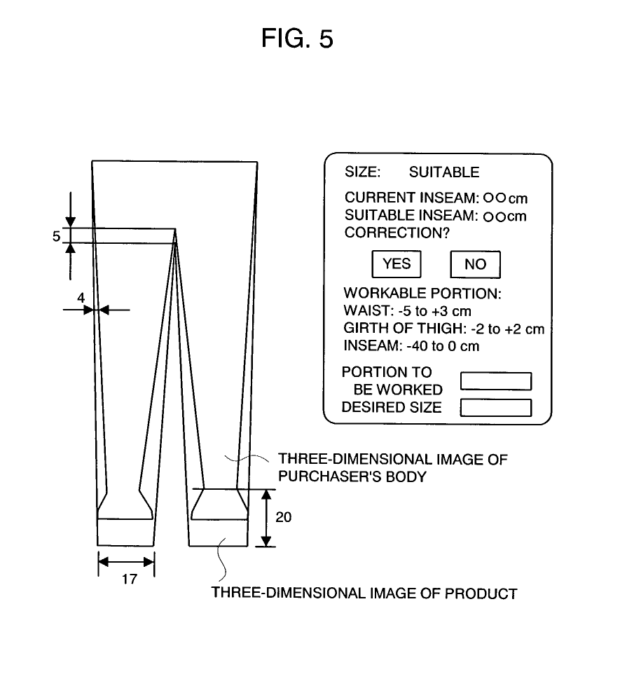

When a product has a workable portion, a product image may be corrected and re-displayed at a purchaser's request. In this case, the workable portion and the allowable work range thereof are first displayed in the synthesis result displaying step S32 of FIG. 3. Meanwhile, a product image is corrected within the allowable range according to the purchaser's request to redisplay an image after working. By doing so, the purchaser can confirm a worked product image before the product is actually worked. Moreover, the sizes of products of some types may be automatically adjusted correctly. Because pairs of slacks, for example, are generally wholesaled to retail shops, without adjusting the hems of them, an extra length is previously assumed as shown in FIG. 5. By automatically tailoring the hem to a purchaser's body size to correct the length, the corrected state may be indicated to the purchaser.

As described above, a purchaser inspects the relationship between the purchaser's body and the product size by means of the image displayed on the purchaser's terminal 10. When the size is changed within an allowable work range, the purchaser ascertains the image of the worked product after working and considers buying the corresponding product. After consideration, when the purchaser decides to buy the product, the work measurements, worked out based on the shape data and measurements of the corrected product, are stored into the purchaser's terminal 10 (step S35 in FIG. 3).

Thereafter, the purchaser's terminal 10 transmits the work measurements to the retail shop's terminal 20 (step S36). The retail shop's terminal 20 stores the information on the work measurements as customer information (step S37). The retail shop's terminal 20 reads information on the product out of the product information database 23, thus creating work information for indicating to the working section 24 (step S38). This work information includes at least work portions, work measurements for each portion, and finished measurements. The working section 24 receives the work information and corrects the product (step S39).

As described above, the configuration and operation of the present invention have been described in detail. However, it should be noted that the technical scope of the present invention is not restricted to only the above embodiment. The present invention can be realized as various modifications. For example, in the above-mentioned embodiment, the purchaser's terminal 10 creates and saves three-dimensional images of a purchaser's body. However, the three-dimensional images may be created and saved on the retail shop's terminal 20 or on the maker's terminal 40.

In the above-mentioned embodiment, the purchaser's terminal 10 communicates information with only the retail shop's terminal 20. However, the purchaser's terminal 10 may be connected directly to the maker's terminal 40 via the network 30 to obtain information about products.

In the above embodiment, when there is no information about a product required by a purchaser, the retail shop's terminal 20 requests the maker's terminal 40 to send the product. However, the configuration may be provided such a way that a retail shop's terminal 20 accesses autonomously a maker terminal 40 every fixed period of time and down-loads and saves information about new products.

As described above, according to the present embodiment, when a purchaser buys a product at a retail shop, he or she can confirm the state of wearing the product of which trial is not allowed, by means of an image. This feature can eliminate anxiety upon purchase and can prevent inconvenience of unfitness after purchase. In contrast, the retail shop can reduce losses in sales for the time period for which purchasers are waiting in front of a fitting room. Moreover, rearranging neatly clothing items after the fitting of purchasers and the man-hour of measuring in the hem adjustment are reduced so that the working efficiency of clerks can be improved.

Moreover, in the tree-dimensional image synthesis of a purchaser's body and a product with extensibility, the three-dimensional image re-synthesis is performed through considering the extensibility. Thus, the wearing image of a product with extensibility can be obtained accurately. Moreover, because the image of a worked product is combined with a body's image, the complaint about the result different from prediction can be avoided.

The entire disclosure of Japanese Patent Application No. 2001-273927 filed on Sep. 10, 2001 including specification, claims, drawings and summary are incorporated herein by reference in its entirely.

What is claimed is:

1 A product selling system, wherein whether or not the size of a product fits the body of a purchaser is determined, comprising:
a purchaser's terminal operated by a purchaser of a product;
a terminal belonging to a seller of an apparel product, communicable to said purchaser's terminal;
body image creating means for creating, based on information on the body type of said purchaser, a three-dimensional image of said body type;
product information providing means for providing information on a product supplied by said seller; and
image synthesizing means for creating a three-dimensional image based on said product information and then synthesizing said created three-dimensional image with the three-dimensional image of said purchaser;
said product information supplied by said product information providing means including at least information on design of said product, measurements of respective portions of said product, and a degree of extension if said product has extensibility;
said image synthesizing means correcting a three-dimensional image of said product within the extension range thereof and re-synthesizing and displaying the corrected information with a three-dimensional image of said purchaser.

2 The product selling system defined in claim 1, wherein, when the outline of said purchaser and the outline of said product interfere with each other in a composite image of the body of said purchaser and said product, said image synthesizing means corrects and re-synthesizes a three-dimensional image of said product.

3 The product selling system defined in claim 1, wherein said product information provided by said product information providing means further includes measurements of said product, if workable, and an allowable work range thereof; and wherein said image synthesizing means corrects a three-dimensional image of said product within the allowable work range thereof, re-synthesizes the corrected three-dimensional image with a three-dimensional image of said purchaser, and then displays a synthesized image.

4 The product selling system defined in claim 3, further comprising working means for working said product at a request from said purchaser.

5 The product selling system defined in claim 4, wherein said image synthesizing means transmits, when an image of said product is corrected, the corrected information to said working means; said working means creates work information on portions and measurements to be worked based on said corrected information, whereby said product is worked.

6 The product selling system defined in claim 1, wherein said seller's terminal comprises a retail shop's terminal installed at each retail shop and a maker's terminal linked to said retail shop's terminal via a network and installed at a production/distribution source of said product, said retail shop's terminal having means that requires, when not having information on a product required by said purchaser, information on said product from said maker's terminal.

7 A product selling system, wherein whether or not the size of a product fits the body of a purchaser is determined, by using a purchaser's terminal operated by a purchaser of a product and an apparel product seller's terminal, communicable to said purchaser's terminal; said apparel product seller's terminal including:
a product information database for holding information on product design provided by said seller, product information including measurements of respective portions and a degree of extension of said product, and product identification information described on a product tag, which are registered correspondingly;
retrieval means for retrieving, in response to an inquiry about product information from said purchaser's terminal, product information corresponding to identification information on the product from said product information database; and
means for transmitting the product information retrieved by said retrieval means to said purchaser's terminal;
said purchaser's terminal including:
means for inputting information on a body type of said purchaser;
body image creation means for creating a three-dimensional image of the body of said purchaser, based on said body type information;
means for creating a three-dimensional image of a product based on information on said product transmitted;
means for synthesizing the three-dimensional image of said purchaser's body with the three-dimensional image of said product; and
correction means for correcting the three-dimensional image of said image within an extension range of said product, based on a degree of extension of said product information.

8 The product selling system defined in claim 7, wherein said correction means comprises:
means for determining an interference portion between the outline of a purchaser's body and the outline of a product in said synthesized image; and
means for correcting a three-dimensional image of said product corresponding to said interference portion determined by said determining means within an extension range of said product.

9 The product selling system defined in claim 7, wherein said apparel product seller's terminal comprises:
a product work information database for holding workable information including a workable portion and an allowable work range of said product and product identification information described on a product tag, which are registered correspondingly;
means for retrieving, in response to an inquiry about product information by said purchaser's terminal, said workable information based on identification information on the inquired product;
means for transmitting said retrieved workable information to said purchaser's terminal; and
means for correcting a three-dimensional image of said product, based on said workable information transmitted.

10 The product selling system defined in claim 7, wherein said purchaser's terminal comprises:
means for computing work portions and work measurements, based on a three-dimensional image of said product corrected by said correction means;
means for creating information on work measurements from said work portions and said work measurements computed; and
means for transmitting said information on said work measurements and said product identification information, to a retail shop's terminal.

11 The product selling system defined in claim 7, further having a maker's terminal installed at a product seller, connected to said apparel product seller's terminal via a network, said maker's terminal comprising:
a product information database for storing information on product design provided by said maker, product information including measurements of respective portions and a degree of extension of said product, and product identification information described on a product tag, which are registered correspondingly;
retrieval means for retrieving, in response to an inquiry about product information from said apparel product seller's terminal, product information corresponding to identification information on said product from said product information database; and
means for transmitting product information retrieved by said retrieval means to said apparel product seller's terminal.

12 A product selling method, wherein whether or not the size of a product fits the body of a purchaser is determined using a purchaser's terminal operated by a purchaser and an apparel product seller's terminal, communicable to said purchaser's terminal, having a product information database, said database holding information on design, product information including measurements of respective portions of said product and a degree of extension of said product and identification information described on a product tag, which are registered correspondingly;
said apparel product seller's terminal including the steps of:
retrieving, in response to an inquiry about product information from said purchaser's terminal, product information corresponding to identification information of the product from said product information database; and
transmitting said retrieved product information to said purchaser's terminal;
said purchaser's terminal including the steps of:
inputting information on a body type of said purchaser;
creating a three-dimensional image of the purchaser's body based on said body type information;
creating a three-dimensional image of a product based on product information transmitted;
synthesizing the three-dimensional image of said purchaser's body with the three-dimensional image of said product; and
correcting the three-dimensional image of said product within an extension range of said product, based on a degree of extension of said product information.

13 The product selling method defined in claim 12, wherein said correcting step comprises the steps of:
determining the outline of the body of said purchaser and the outline of said product in said synthesized image; and
correcting a three-dimensional image of said product corresponding to an interference portion determined in said determining step, within said product extension range.
